(19) United States
(12) Patent Application Publication
(10) Pub. No.: US 2026/0197665 A1
(43) Pub. Date: Jul. 9, 2026

(54) CELL PLANNING TOOL

(71) Applicant: DISH Wireless L.L.C., Englewood, CO (US)

(72) Inventors: Greg Ivey, Littleton, CO (US); Deja Brule, Denver, CO (US)

(21) Appl. No.: 19/010,791

(22) Filed: Jan. 6, 2025

(51) Int. Cl. H04W 16/18; G06Q 10/0834

(52) U.S. Cl. CPC H04W 16/18; G06Q 10/08345

(57) ABSTRACT

A disclosed method may include (i) receiving, through a cell planning software tool, as a first input a respective value for each field in a set of fields comprising a high spectrum area indication, a cabinet type, a cooling unit type, a node support type, a distributed unit type, and an area of interest, (ii) receiving, through the cell planning software tool, as a second value a specification of a number of distributed units or a number of nodes, and (iii) retrieving, by the cell planning software tool, in response to receiving the first input, underlying calculation values that match the first input for calculating cabinet power, cabinet cooling, or pricing.

### BRIEF SUMMARY

This disclosure is generally directed to systems, methods, and computer-readable media relating to a cell planning tool. Cellular network planning and deployment may present complex challenges for mobile operators. As networks expand and evolve to meet growing demand, operators may face difficulties in efficiently designing and implementing cell sites, particularly when it comes to small cell deployments. The process of planning and optimizing cell site configurations may involve numerous variables and constraints that interact in complex ways. Without sophisticated tools, planners may struggle to account for all relevant factors and identify optimal solutions. This may potentially lead to suboptimal network designs, inefficient use of resources, and increased deployment costs. Additionally, different teams within an organization may work in silos, using their own methodologies and assumptions, which may result in inconsistencies and errors when attempting to integrate various aspects of the cell planning process. Developing a comprehensive and user-friendly cell planning tool that may centralize information, automate calculations, and provide actionable insights may help address many of these challenges.

One challenge that mobile operators may encounter relates to equipment limitations and compatibility. Different types of cabinets, cooling units, and network equipment may have varying specifications and constraints that affect the overall cell site design. For example, the cooling capacity of a particular cabinet may limit the number of distributed units or nodes that may be supported at a given site. Similarly, the power requirements and heat generation of various components need to be balanced to ensure proper functioning within the available infrastructure. Without a centralized system for tracking and analyzing these equipment specifications, planners may struggle to quickly determine feasible configurations or identify potential bottlenecks. This may lead to designs that appear viable on paper but prove impractical or inefficient when implemented in the field. A cell planning tool that incorporates detailed equipment specifications and automatically checks for compatibility and limitations may help streamline the planning process and reduce the risk of errors or suboptimal designs.

Another potential issue in cell planning involves accounting for regional variations in factors such as power costs, climate conditions, and spectrum availability. Different markets or areas of interest may have unique characteristics that significantly impact the feasibility and cost-effectiveness of particular cell site configurations. For instance, power costs may vary dramatically between utility providers and geographic locations, affecting the operational expenses associated with a given design. Similarly, climate differences may influence cooling requirements and equipment performance. Spectrum availability and regulations may also differ by region, potentially limiting the options for radio configurations in certain areas. Without a systematic way to incorporate these regional factors into the planning process, operators may struggle to optimize their network designs for specific localities or to make informed decisions about resource allocation across different markets. A cell planning tool that may integrate region-specific data and automatically adjust calculations and recommendations based on local conditions may help planners develop more tailored and cost-effective network solutions.

Coordination between different teams and departments within a mobile operator's organization may present another set of challenges in the cell planning process. RF engineers, network designers, construction managers, and financial planners may all have input into the cell site design process, but they may use different tools, methodologies, or assumptions in their work. This may lead to communication gaps, inconsistencies, and potential errors when attempting to integrate various aspects of the planning process. For example, an RF engineer might design a cell site configuration based on coverage requirements, without fully accounting for the physical limitations of available equipment or the financial constraints of the project. Similarly, a construction manager might approve a site layout without realizing that it exceeds the available power or cooling capacity. These disconnects may result in delays, rework, and suboptimal network designs. A centralized cell planning tool that brings together inputs and constraints from various stakeholders may help foster better collaboration and ensure that all relevant factors are considered throughout the planning process.

To address these challenges, a comprehensive cell planning software tool may be developed to streamline and optimize the planning process. Such a tool may integrate various aspects of cell site design, including equipment specifications, regional data, and inputs from different teams, into a unified platform. By centralizing this information and automating complex calculations, the tool may help planners quickly evaluate multiple scenarios and identify optimal configurations. For example, the tool may enable users to input key parameters such as the desired number of nodes, cabinet type, and area of interest, and then automatically calculate power requirements, cooling capacity, and estimated costs based on the specific equipment and regional factors involved. This may save time and reduce the risk of errors compared to manual calculations or the use of multiple disconnected tools.

One potential feature of an advanced cell planning tool may be the ability to visualize feasible configurations and constraints in an intuitive manner. For instance, the tool may generate color-coded outputs or multi-dimensional graphs that clearly indicate whether a proposed configuration is viable based on various technical and financial constraints. This visual feedback may enable planners to quickly identify potential issues and adjust their designs accordingly. Additionally, the tool may potentially suggest the nearest feasible configuration when an initial proposal is not viable, helping users iteratively refine their designs. By providing clear, visual representations of complex data and relationships, the tool may make it easier for team members from different backgrounds to understand and collaborate on cell site planning decisions.

Another valuable capability of a cell planning tool may be the integration of live data updates and predictive analytics. As equipment specifications, costs, and other relevant factors change over time, the tool may potentially be designed to automatically incorporate these updates into its calculations and recommendations. This may help ensure that planners are always working with the most current information, potentially leading to more accurate and cost-effective designs. Furthermore, the tool may potentially leverage historical data and trends to provide forecasts and predictions about future network performance, costs, or capacity requirements. For example, it may analyze patterns in power consumption or traffic growth to help planners anticipate future needs and design more scalable solutions. By incorporating these forward-looking capabilities, the cell planning tool may potentially help operators make more informed long-term decisions about their network deployments.

In some examples, a method includes (i) receiving, through a cell planning software tool, as a first input a respective value for each field in a set of fields comprising a high spectrum area indication, a cabinet type, a cooling unit type, a node support type, a distributed unit type, and an area of interest, (ii) receiving, through the cell planning software tool, as a second value a specification of a number of distributed units or a number of nodes, (iii) retrieving, by the cell planning software tool, in response to receiving the first input, underlying calculation values that match the first input for calculating cabinet power, cabinet cooling, or pricing, (iv) outputting, through the cell planning software tool, an estimate of cabinet power, cabinet cooling, or pricing for a corresponding cell site that is based on an application to the second input of the underlying calculation values that were retrieved in response to receiving the first input, and (v) initiating building, in response to the cell planning software tool outputting the estimate, a corresponding cell site that conforms to the first input or the second input.

In some examples, outputting the estimate is conditioned upon receiving input for all six fields of the first input.

In some examples, outputting the estimate comprises color-coding the output based on feasibility.

In some examples, the color-coding comprises using green to indicate a feasible configuration or red to indicate an infeasible configuration.

In some examples, the method comprises automatically suggesting a nearest feasible configuration by adjusting an input parameter in response to the estimate indicating an infeasible configuration and outputting the nearest feasible configuration through the cell planning software tool.

In some examples, retrieving the underlying calculation values comprises incorporating a live data update for pricing information from a supply chain pricing contract.

In some examples, outputting the estimate comprises calculating and including power output or spare power capacity based on the first input and the second input.

In some examples, the underlying calculation values account for an accounted capacity scenario including a 75% capacity scenario or a 100% capacity scenario.

In some examples, outputting the estimate comprises performing a cooling load calculation using an equipment specification designated by the first input.

In some examples, the method comprises visualizing a feasible configuration in a multi-dimensional graph based on the first input and the second input and displaying the multi-dimensional graph through the cell planning software tool.

In some examples, the method comprises forecasting a future cost based on a current trend in power consumption, equipment prices, or operational expenses and incorporating the forecasted future cost into the estimate or outputting the forecasted future cost separately through the cell planning software tool.

In some examples, the method comprises integrating with a data visualization tool and generating an interactive report dashboard for the estimate through the data visualization tool.

In some examples, retrieving the underlying calculation values comprises automatically updating a seasonal power consumption trend.

In some examples, outputting the estimate comprises calculating a maximum number of nodes supported by a given number of distributed units based on the first input and including the calculated maximum number of nodes in the estimate.

In some examples, outputting the estimate comprises checking port availability in a Cell Site Router (CSR) based on the calculated number of distributed units and including the port availability information in the estimate.

In some examples, the method comprises comparing the estimate to predefined budget constraints and outputting a feasibility indication based on the comparison through the cell planning software tool.

In some examples, a non-transitory computer-readable medium has instructions stored thereon that, when executed by at least one physical computing processor, cause a computing device to perform operations comprising (i) receiving, through a cell planning software tool, as a first input a respective value for each field in a set of fields comprising a high spectrum area indication, a cabinet type, a cooling unit type, a node support type, a distributed unit type, and an area of interest, (ii) receiving, through the cell planning software tool, as a second value a specification of a number of distributed units or a number of nodes, (iii) retrieving, by the cell planning software tool, in response to receiving the first input, underlying calculation values that match the first input for calculating cabinet power, cabinet cooling, or pricing, (iv) outputting, through the cell planning software tool, an estimate of cabinet power, cabinet cooling, or pricing for a corresponding cell site that is based on an application to the second input of the underlying calculation values that were retrieved in response to receiving the first input, and (v) initiating building, in response to the cell planning software tool outputting the estimate, a corresponding cell site that conforms to the first input or the second input.

In some examples, a system comprises at least one physical computing processor of a computing device and a non-transitory computer-readable medium that has instructions stored thereon that, when executed by the at least one physical computing processor, cause the computing device to perform operations comprising (i) receiving, through a cell planning software tool, as a first input a respective value for each field in a set of fields comprising a high spectrum area indication, a cabinet type, a cooling unit type, a node support type, a distributed unit type, and an area of interest, (ii) receiving, through the cell planning software tool, as a second value a specification of a number of distributed units or a number of nodes, (iii) retrieving, by the cell planning software tool, in response to receiving the first input, underlying calculation values that match the first input for calculating cabinet power, cabinet cooling, or pricing, (iv) outputting, through the cell planning software tool, an estimate of cabinet power, cabinet cooling, or pricing for a corresponding cell site that is based on an application to the second input of the underlying calculation values that were retrieved in response to receiving the first input, and (v) initiating building, in response to the cell planning software tool outputting the estimate, a corresponding cell site that conforms to the first input or the second input.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to cell planning.

FIG. 2 illustrates an example of a graphical user interface for a cell planning software tool.

FIG. 3 shows an example visualization of feasible and infeasible configurations output by the cell planning software tool.

FIG. 4 illustrates an example of how the cell planning software tool may suggest the nearest feasible configuration when an infeasible configuration is input.

FIG. 5 depicts an example of live data updates and power calculations performed by the cell planning software tool.

FIG. 6 shows an example of cooling load calculations and visualization provided by the cell planning software tool.

FIG. 7 illustrates an example multi-dimensional feasibility visualization and budget comparison output by the cell planning software tool.

FIG. 8 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and enables for being based on additional features, functions, aspects, or limitations not described, unless the context clearly dictates otherwise. In addition, throughout the specification, the meaning of “a,” “an,” and “the” include singular and plural references.

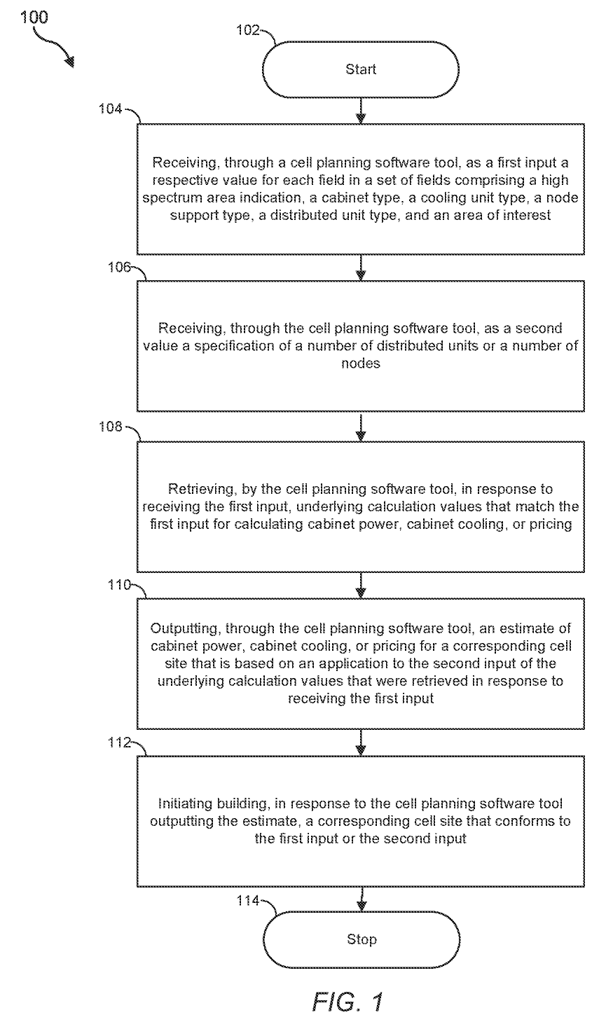

FIG. 1 shows a flow diagram for a method 100 relating to cell planning. At step 102, method 100 may start. At step 104, method 100 includes receiving, through a cell planning software tool, as a first input a respective value for each field in a set of fields comprising a high spectrum area indication, a cabinet type, a cooling unit type, a node support type, a distributed unit type, and an area of interest. At step 106, method 100 includes receiving, through the cell planning software tool, as a second value a specification of a number of distributed units or a number of nodes. At step 108, method 100 includes retrieving, by the cell planning software tool, in response to receiving the first input, underlying calculation values that match the first input for calculating cabinet power, cabinet cooling, or pricing. At step 110, method 100 includes outputting, through the cell planning software tool, an estimate of cabinet power, cabinet cooling, or pricing for a corresponding cell site that is based on an application to the second input of the underlying calculation values that were retrieved in response to receiving the first input. At step 112, method 100 includes initiating building, in response to the cell planning software tool outputting the estimate, a corresponding cell site that conforms to the first input or the second input. At step 114, method 100 ends.

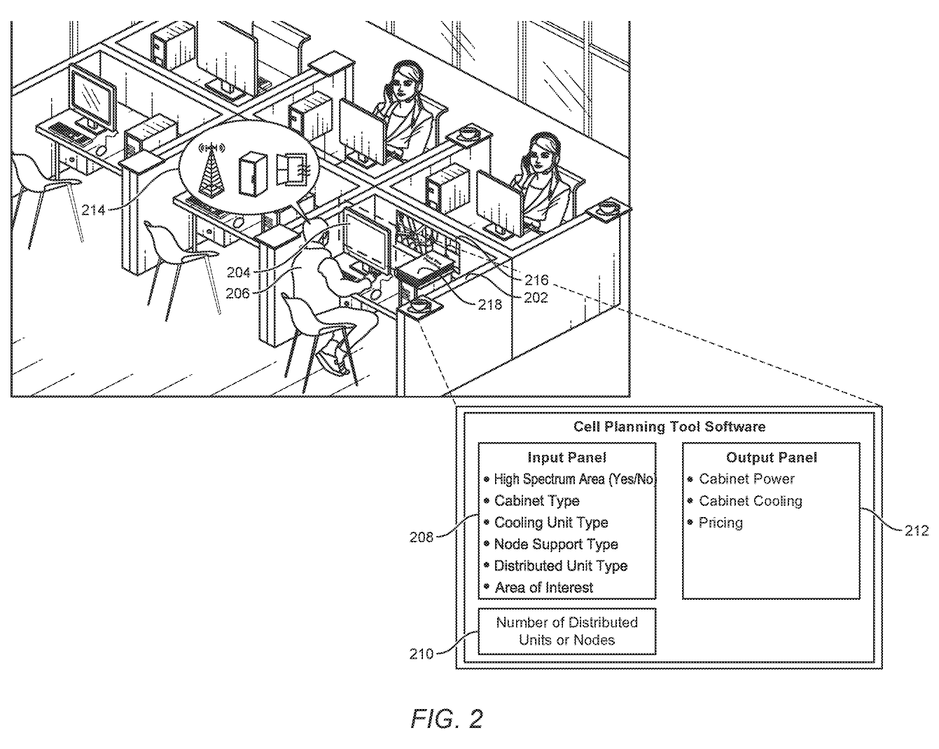

FIG. 2 illustrates an example of a graphical user interface that may be utilized for a cell planning software tool. The figure shows a person 206 seated at a desk 202, interacting with a computer system that may display the cell planning software tool interface on a large monitor 204. The person 206 may represent a cell planning engineer or other professional involved in the cell site planning process.

The computer monitor 204 may display the user interface of the cell planning software tool, which may be divided into several sections to facilitate efficient input and output of data relevant to cell site planning. On the left side of the screen, an input panel 208 may be visible, presenting six distinct input fields that correspond to key parameters in cell site planning. These fields may include options for specifying a high spectrum area indication, selecting a cabinet type, choosing a cooling unit type, determining the node support type, specifying the distributed unit type, and designating an area of interest. The inclusion of these specific fields in the input panel 208 may enable cell planners to input helpful information that may affect the feasibility and efficiency of a proposed cell site configuration.

In some examples, the cell planning software tool may accept a high spectrum area indication as one of the six inputs. This input may be in the form of a binary indication, where users may specify whether the planned cell site is located in a high spectrum area or not. High spectrum areas may be regions where higher frequency bands may be available for cellular communications, which may potentially impact the overall design and capabilities of the cell site. For instance, urban areas or densely populated regions might be more likely to be designated as high spectrum areas due to the potential increased demand for data capacity. The format for entering this input may be a simple yes/no selection or a checkbox in the user interface. The relevance of this input may lie in its potential impact on the choice of equipment, power requirements, and overall cell site configuration. High spectrum areas may require different types of antennas or distributed units that may handle higher frequency bands, which may potentially affect the power consumption and cooling needs of the site.

In some examples, the cell planning software tool may be configured to output the estimate only when input is received for all six fields of the first input (or a customized number of fields). This condition may ensure that the tool has comprehensive information before generating estimates, potentially leading to more accurate and reliable results. The requirement for complete input may also help users understand the importance of each field in the planning process, encouraging them to gather all important data before proceeding with the analysis. In scenarios where not all information is available, the tool might provide partial results or estimates with clearly marked caveats, indicating the potential impact of missing data on the accuracy of the output.

Cabinet type may be another input that the cell planning software tool may accept. This input may enable users to select from a predefined list of cabinet types that may be commonly used in cell site deployments. The tool may include options for at least four different cabinet types, with the possibility of adding more in other embodiments. Examples of cabinet types may include options like "Charles," "Delta," "Great Lakes," and "Intercess," each with its own specific characteristics and capabilities. The format for entering this input may be a dropdown menu or a set of radio buttons, potentially enabling users to select the appropriate cabinet type for their planning scenario. The choice of cabinet type may be relevant to the overall cell site design, as different cabinets may have varying cooling capacities, space limitations, and compatibility with other equipment. For instance, the transcript mentions that a one cabinet type may enable for more cooling capacity, potentially supporting a greater number of nodes compared to other cabinet types.

Cooling unit type may be a third input that the cell planning software tool may accommodate. This input may enable planners to specify the type of cooling solution that may be used at the cell site. There may be at least two main categories of cooling units: HVAC (Heating, Ventilation, and Air Conditioning) and HEXS (Heat Exchanger System). HVAC may be considered an active cooling solution, while HEXS may be an ambient cooling solution. The format for entering this input may be a dropdown menu or toggle switch between these two main options, with the possibility of including additional cooling unit types in other iterations of the tool. The choice of cooling unit type may be relevant to the overall cell site design and performance, as it may directly impact the ability to maintain optimal operating temperatures for the equipment. Different cooling unit types may have varying efficiencies and capacities, which may potentially affect the number of distributed units or nodes that may be supported at a given site. Cooling capacity may often be a limiting factor in cell site design, which may make this input particularly useful for accurate planning.

In some examples, the cell planning software tool may accept node support type as another input. This input may enable users to specify whether the planned cell site may be supporting a macro site or if it may be a dedicated cabinet for small cell deployments. The format for entering this information may be a binary selection, such as a radio button or toggle switch, between "Macro Support" and "Dedicated Cabinet." The relevance of this input may lie in its potential impact on the available capacity for supporting distributed units or nodes. As explained by the inventors, a cabinet supporting a macro site may need to allocate resources for the macro site's equipment, including rectifiers that may generate substantial heat. This may potentially limit the number of additional nodes that may be supported. In contrast, a dedicated cabinet that is not supporting a macro site may have more capacity available for small cell nodes, as it may not account for the power and cooling requirements of macro site equipment. This input may thus play a role in determining the feasible configurations for a given cell site.

Distributed unit type may be another input that the cell planning software tool may incorporate. This input may enable planners to specify the type of distributed unit that may be used in the cell site configuration. Examples of distributed unit types may include options such as "XR11" or "Super Micro." The format for entering this input may be a dropdown menu or a set of radio buttons, potentially enabling users to select from a list of supported distributed unit types. The choice of distributed unit type may be relevant to the overall cell site design, as different units may have varying processing capabilities, power requirements, and heat generation characteristics. For instance, a Super Micro unit, despite having a 24-core processor, may not be able to carry as much load as an XR11 unit. This input may therefore have a potential impact on the number of nodes that may be supported and the overall performance of the cell site.

Area of interest (AOI) may be the sixth input that the cell planning software tool may accept. This input may enable users to specify the geographic location or market where the cell site may be planned. The format for entering this information may be a dropdown menu of predefined markets or a text field where users may input a specific location name. The relevance of this input may be multifaceted and may have implications for the cell site planning process. The AOI may potentially influence various factors such as power costs, climate conditions, and spectrum availability. For example, power costs may vary between different utility companies and geographic locations, which may potentially impact the operational expenses associated with a given cell site design. Climate differences between AOIs may affect cooling requirements and equipment performance. Additionally, spectrum availability and regulations may differ by region, potentially influencing the options for radio configurations in certain areas. By incorporating the AOI input, the cell planning tool may access and apply location-specific data to provide estimates for power consumption, cooling requirements, and overall costs.

In some examples, the cell planning software tool may utilize six input factors to generate comprehensive estimates for cell site planning. These factors may include high spectrum area indication, cabinet type, cooling unit type, node support type, distributed unit type, and area of interest. While all six factors may contribute to a detailed analysis, the tool may also function effectively with fewer inputs. For instance, in certain scenarios, planners may opt to use only five of the six factors, such as omitting the high spectrum area indication if all sites in a region share the same spectrum characteristics. In other cases, four factors might suffice, potentially excluding both the high spectrum area indication and the distributed unit type if standardized equipment is used across multiple sites. Some users might find that three factors (perhaps cabinet type, cooling unit type, and area of interest) may provide sufficient information for initial planning stages. The tool may even accommodate scenarios where only two factors, such as cabinet type and area of interest, are considered for high-level estimations. In some cases, a single factor like area of interest might be used to generate broad, region-specific guidelines. The flexibility of the tool may enable for various combinations of these factors, potentially covering all permutations from using all six inputs to relying on just one or two key parameters.

In addition to the six primary input factors, the cell planning software tool may be expanded in the future to incorporate a wide array of additional parameters that may enhance its predictive capabilities and accuracy. For example, the tool may potentially include a "terrain type" input, enabling users to specify whether the cell site will be located in urban, suburban, rural, or mountainous areas, as this may significantly affect signal propagation and coverage estimates. A "population density" factor might be added to help predict potential network load and capacity requirements in different regions. The tool may also incorporate a "weather patterns" input, considering factors like average rainfall, temperature extremes, or likelihood of natural disasters, which may impact equipment selection and site hardening requirements. An "existing infrastructure" parameter might enable planners to input information about nearby cell sites or fiber optic networks, potentially influencing decisions about new site locations or backhaul options. A "regulatory environment" factor may be included to account for local zoning laws, permitting processes, or spectrum licensing requirements that may vary by jurisdiction. The tool might also add a "future growth projections" input, enabling planners to factor in anticipated population changes or economic development in the area of interest. An "energy source" parameter may be incorporated to specify whether the site will rely on grid power, solar panels, or backup generators, potentially affecting power consumption calculations and site design. A "site accessibility" factor might be useful for estimating maintenance costs and influencing equipment choices based on how easily technicians may reach the location. The tool may potentially include a "network technology" input to specify whether the site will support 4G, 5G, or future generations of cellular technology, as each may have different equipment and configuration requirements. An "environmental impact" factor might be added to help planners assess and minimize the ecological footprint of new cell sites. These additional factors, along with many others that may be conceived as cellular technology and planning practices evolve, may significantly enhance the tool's ability to provide comprehensive and accurate cell site planning recommendations.

In some scenarios, the cell planning software tool interface may display all available input options, but not all of these may be important for every planning situation. Some factors may be considered essential for basic functionality, while others might be optional depending on the specific planning context or level of detail indicated. For instance, the area of interest input might be considered a parameter in most cases, as it may provide context for region-specific factors like power costs and climate conditions. However, the high spectrum area indication might be optional in scenarios where all sites in a given region share the same spectrum characteristics. The cabinet type input may be used for accurate power and cooling estimates, but in some cases, planners might opt to use a default or standardized cabinet type across multiple sites, making this input less helpful for certain analyses. The cooling unit type might be considered optional in temperate climates where passive cooling solutions are sufficient, but it may be more helpful in extreme environments where active cooling is important. The node support type input might be helpful when planning sites that may potentially support both macro and small cell configurations, but it might be less relevant in deployments focused exclusively on one type of cell site. The distributed unit type may be an input for detailed planning and equipment ordering, but it might be considered optional in early-stage, high-level network planning. In some cases, planners might choose to run multiple scenarios with different combinations of inputs to compare outcomes and identify the most important factors for their specific planning needs. The tool's interface may potentially include visual cues or tooltips to guide users on which inputs are considered essential for basic functionality and which are optional for more detailed analysis. This flexibility in input requirements may enable the tool to accommodate a wide range of planning scenarios, from quick, high-level estimates to detailed, site-specific configurations, potentially enhancing its utility across various stages of the network planning process.

Below the main input panel, a separate input field 210 is present, which is labeled to indicate that it accepts input for either the number of distributed units or the number of nodes or both. This field may provide flexibility for planners to specify the scale of the cell site based on their specific requirements, constraints, and/or preferences. The right side of the screen features an output panel 212 that may display the estimates generated by the cell planning software tool. This panel may show calculated values for cabinet power, cabinet cooling, and/or pricing, which may be helpful factors in determining the viability and cost-effectiveness of a proposed cell site configuration.

In some examples, the cell planning software tool may accommodate input for either the number of distributed units (DUs) or the number of nodes, or potentially both, depending on the specific planning scenario and user preferences. A distributed unit (DU) may be understood as a component in modern cellular network architectures, particularly in the context of 5G deployments. DUs may handle baseband processing functions and may be located closer to the antenna sites, potentially enabling more efficient network designs. The number of DUs in a cell site configuration may be an indicator of the site's processing capacity and may influence factors such as power consumption, cooling requirements, and overall system performance. Nodes, on the other hand, may refer to the individual antenna units or radio heads that transmit and receive cellular signals. The number of nodes may be related to the coverage area and capacity of the cell site, with more nodes potentially enabling greater coverage or higher data throughput in a given area. The choice between inputting the number of DUs or nodes, or both, may depend on various factors such as the specific network architecture being planned, the level of detail important in the analysis, or the particular terminology preferences of the network operator or planning team.

The interaction between the DU/node number input and the six fields (high spectrum area indication, cabinet type, cooling unit type, node support type, distributed unit type, and area of interest) may be complex and multifaceted. For instance, the high spectrum area indication may influence the number of nodes or DUs indicated to provide adequate coverage, as higher frequency spectrum may potentially require more densely packed nodes to overcome signal attenuation. The cabinet type may potentially limit the maximum number of DUs or nodes that may be supported due to space constraints or power distribution capabilities. The cooling unit type may affect the number of DUs or nodes that may be accommodated based on the total heat load that may be managed within the cabinet. The node support type (e.g., macro site support or dedicated small cell cabinet) may influence the available resources for DUs or nodes, potentially limiting their number based on power and cooling capacity. The distributed unit type may affect how many nodes may be supported by each DU, which may in turn influence the total number of DUs important for a given number of nodes. The area of interest may potentially impact the indicated number of DUs or nodes based on factors such as population density, terrain, or local regulations governing cell site deployments.

When the six fields are input into the cell planning software tool, they may trigger the retrieval of underlying calculation values from a database or other data source. These fetched data items may include a wide range of parameters that are relevant to cell site planning. For example, the tool may retrieve power consumption specifications for the selected cabinet type and distributed unit type. It may fetch cooling capacity data for the specified cooling unit type, potentially including factors such as efficiency curves at different ambient temperatures. The tool may retrieve radio frequency propagation models specific to the indicated high spectrum area and area of interest, which may be used to estimate coverage and capacity. Cost data associated with equipment, installation, and operations in the specified area of interest may also be fetched. Additionally, the tool may retrieve regulatory information relevant to the area of interest, such as maximum permissible exposure limits for radio frequency emissions or local zoning restrictions that may affect cell site configurations. These fetched data may serve as the foundation for the subsequent calculations and estimates generated by the tool.

In some examples, the process of retrieving underlying calculation values may include automatically updating seasonal power consumption trends. This feature recognizes that power requirements for cell sites may vary significantly based on seasonal factors such as temperature, humidity, or usage patterns. The tool might access historical power consumption data, correlate it with seasonal variables, and use this information to adjust its calculations based on the time of year or projected weather conditions. By incorporating these seasonal trends, the cell planning software may provide more accurate estimates of power requirements and operational costs throughout the year, potentially helping planners design more efficient and cost-effective cell sites that may handle seasonal variations in demand and environmental conditions.

More generally, in some examples, the process of retrieving underlying calculation values may incorporate live data updates for pricing information from supply chain pricing contracts. This feature may help ensure that the cell planning software tool is working with the most up-to-date cost information, potentially leading to more accurate budget estimates and financial planning. The tool might establish direct connections with supply chain management systems or databases, enabling real-time or near-real-time updates to pricing data. This dynamic technique to data retrieval may be particularly valuable in industries where equipment prices may fluctuate frequently due to market conditions, technological advancements, or changes in supplier relationships.

The application of the fetched data to the DU/node number input may involve a series of calculations and analyses within the cell planning software tool. In some scenarios, the DU/node number itself may not directly trigger additional data fetching but may instead be used as a multiplier or scaling factor applied to the data fetched based on the six fields. For instance, the power consumption data fetched for a single DU may be multiplied by the input number of DUs to estimate total power requirements. Similarly, the cooling load generated by a single node may be scaled up based on the input number of nodes to calculate the total cooling capacity needed. However, in other cases, the DU/node number input may indeed lead to the fetching of additional underlying data. For example, entering a specific number of DUs may cause the tool to retrieve data about the maximum number of nodes that may be supported by that many DUs, based on the selected distributed unit type. The tool may also fetch data about the required switch port capacity or backhaul bandwidth needed to support the specified number of DUs or nodes. In some embodiments, the tool may use the DU/node number to retrieve pre-calculated configuration templates or reference designs that closely match the input parameters, potentially streamlining the planning process for common scenarios. The specific calculations and data applications may vary depending on the tool's design and the particular cell site planning methodology being employed, but the overall goal may be to generate comprehensive estimates of power requirements, cooling needs, equipment specifications, and costs based on the combination of the six field inputs and the DU/node number.

In some examples, the cell planning software tool may calculate the maximum number of nodes that may be supported by a given number of distributed units based on the first input, and include this information in the estimate. This calculation may take into account factors such as the processing capacity of the distributed units, power constraints, cooling capabilities, and/or network architecture considerations. By providing this maximum node capacity information, the tool may help planners understand the scalability and potential for future expansion of a proposed cell site configuration. This feature might also assist in optimizing the balance between distributed units and nodes, potentially leading to more efficient use of resources and improved network performance.

In some examples, the cell planning software tool may receive, as a second value, a specification of a number of distributed units or a number of nodes. This capability may be illustrated by the separate input field 210 in the figure, which may provide a dedicated space for users to enter this scaling information. By enabling input for either distributed units or nodes, the tool may offer flexibility to accommodate different planning techniques or terminology preferences among users.

In some examples, the cell planning software tool may generate outputs related to cabinet power, cabinet cooling, and pricing for a corresponding cell site. These outputs may be presented individually or in various combinations, depending on the specific planning needs and user preferences. The cabinet power output may provide an estimate of the total power consumption for the proposed cell site configuration. This output may be expressed in watts or kilowatts and may reflect the cumulative power requirements of all equipment within the cabinet, including distributed units, cooling systems, and any additional components specified in the input parameters. The significance of the cabinet power output may lie in its potential to inform decisions about power supply requirements, energy efficiency measures, and operational costs associated with electricity consumption. Planners may use this information to ensure that adequate power resources are available at the proposed site location, or to compare different configuration options in terms of their energy efficiency.

The cabinet cooling output may offer an estimate of the cooling capacity required to maintain optimal or other operating temperatures within the cell site cabinet. This output may be expressed in British Thermal Units (BTUs) or other appropriate units of cooling capacity. The cooling output may take into account the heat generated by all equipment within the cabinet, as well as environmental factors such as ambient temperature in the specified area of interest. The importance of the cabinet cooling output may stem from its role in ensuring the longevity and reliable operation of cell site equipment. Inadequate cooling may potentially lead to equipment failures, reduced performance, or shortened lifespan of components. Planners may use this output to select appropriate cooling solutions, determine the feasibility of passive cooling in certain environments, or assess the need for additional climate control measures in extreme conditions.

Pricing output from the cell planning software tool may provide an estimate of the costs associated with the proposed cell site configuration. This output may encompass various cost elements, potentially including equipment costs, installation expenses, operational expenditures, and even projected maintenance costs over a specified period. The pricing output may be a important factor in budget planning and financial feasibility assessments for network deployments. It may enable planners to compare the cost-effectiveness of different configuration options, assess the return on investment for proposed sites, or optimize resource allocation across multiple cell site projects. The pricing output may also help in negotiations with equipment vendors or in preparing bids for network deployment contracts.

In some scenarios, users of the cell planning software tool may choose to focus on a single output, such as cabinet power, if their primary concern is energy efficiency or power supply planning. In other cases, planners might prioritize the cabinet cooling output, particularly in regions with extreme climates where thermal management is a challenge. The pricing output might be the sole focus in situations where budget constraints are the primary driver of planning decisions. However, the tool may offer the flexibility to consider any combination of two or more outputs, such as power and cooling, cooling and pricing, or power and pricing. Each of these pairings may provide valuable insights into different aspects of cell site planning. For instance, examining power and cooling outputs together may help in optimizing the overall efficiency of the site, while considering cooling and pricing might assist in balancing thermal management needs with budget limitations.

The relative importance of these outputs may vary depending on the specific planning context, regional factors, and organizational priorities. In some cases, the cabinet power output might be considered more relevant, particularly in areas where power resources are scarce or expensive. The cooling output might take precedence in regions with extreme temperatures or in scenarios involving high-density equipment configurations. The pricing output may be viewed as a more relevant factor in highly competitive markets or in situations where cost optimization is a primary goal. Nevertheless, these outputs are often interdependent and may synergize in ways that provide comprehensive insights into cell site feasibility and optimization.

For example, a reduction in cabinet power requirements might lead to lower cooling needs, potentially resulting in cost savings reflected in the pricing output. Similarly, investing in more efficient cooling solutions might enable for higher power density within the cabinet, potentially enabling more capable configurations without increasing the overall footprint. The pricing output may reflect these interrelationships, potentially showing how upfront investments in more efficient equipment or cooling solutions might lead to long-term operational cost savings. By considering these outputs in combination, planners may potentially achieve a more holistic understanding of the trade-offs and optimizations available in cell site design.

In addition to the primary outputs of cabinet power, cabinet cooling, and pricing, In some example embodiments, the cell planning software tool incorporatescell planning software tool a range of supplementary outputs to provide even more comprehensive planning insights. For instance, a coverage prediction output may estimate the expected signal strength and quality across the intended service area based on the input parameters and local topography. A capacity analysis output might provide estimates of the maximum number of simultaneous users or the peak data throughput that the proposed configuration may support. An environmental impact assessment output may evaluate factors such as electromagnetic emissions, visual impact, or carbon footprint of the proposed cell site.

The tool might also generate a reliability prediction output, estimating the expected uptime and mean time between failures based on the selected equipment and environmental conditions. A maintenance scheduling output may suggest optimal timing for routine servicing based on equipment specifications and local factors. An upgrade path analysis output might provide recommendations for future enhancements or expansions of the cell site, considering technological trends and projected demand growth. A regulatory compliance output may flag any potential issues with local zoning laws, emissions standards, or other relevant regulations based on the proposed configuration and location. These additional outputs, while not necessarily included in all implementations of the tool, may significantly enhance its utility in comprehensive cell site planning and long-term network strategy development.

To provide context for the cell planning process, the figure may include additional elements that represent the broader environment in which cell planning occurs. A thought bubble 214 is shown above the person, containing simplified icons that represent a cell tower, a cabinet, and a cooling unit. These icons symbolize components and considerations involved in the cell planning process, visually reinforcing the purpose and scope of the software tool.

The surroundings of the workstation may further emphasize the cell planning context. A large map 216 may be visible on the wall behind the desk, potentially showing a city or region with markers indicating potential cell site locations. This map may serve as a visual reminder of the geographical and spatial aspects of cell planning, which may be factors considered by the software tool when processing inputs and generating outputs. On the desk 202, additional items are present to create a realistic office environment and reinforce the professional nature of the cell planning process. A notebook 218 is visible, with "Cell Site Planning" written on its cover, suggesting ongoing documentation and note-taking as part of the planning process.

In some examples, the cell planning software tool may output an estimate of cabinet power, cabinet cooling, and/or pricing for a corresponding cell site. This output may be based on an application of the second input to underlying calculation values that may be retrieved in response to receiving the first input. The output panel 212 shown in the figure may represent this functionality, providing a clear and organized display of the estimated values generated by the tool based on the user's inputs. By visually representing both the input and output aspects of the cell planning software tool, along with contextual elements of the planning environment, FIG. 2 may effectively illustrate the user interface and typical usage scenario of the tool. This visual representation may help contextualize the abstract concept of the cell planning tool within a real-world setting.

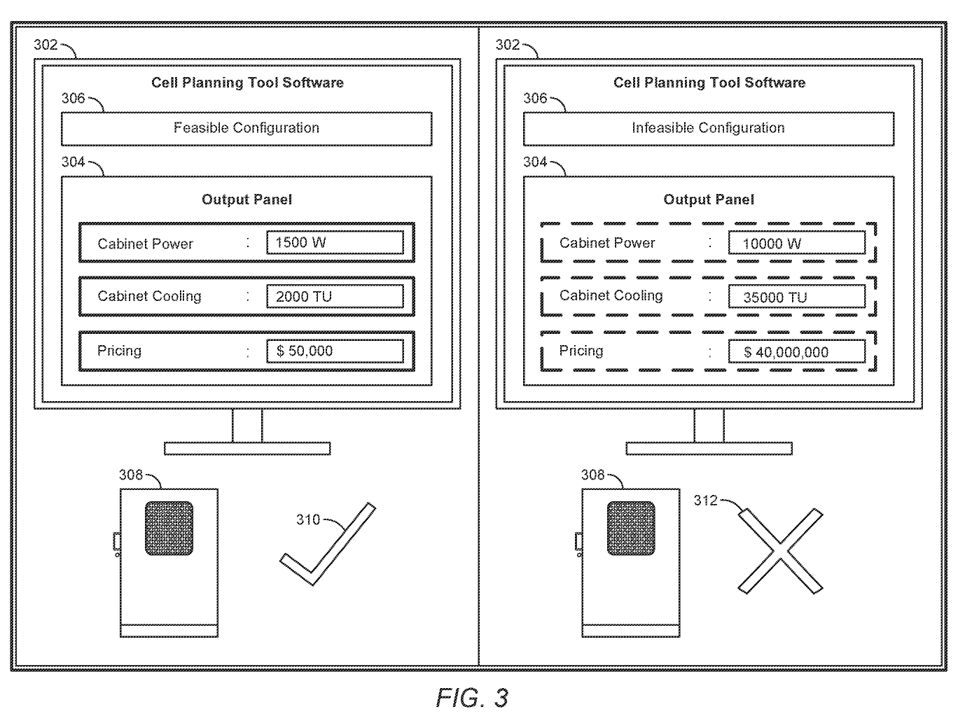

FIG. 3 shows an example visualization of feasible and infeasible configurations output by the cell planning software tool. The figure is divided into two main panels, illustrating the contrast between a feasible configuration on the left and an infeasible configuration on the right.

In the left panel, a large rectangular frame 302 represents a computer screen displaying the cell planning software tool interface for a feasible configuration. Within this screen, an output panel 304 is visible, divided into three sections clearly labeled "Cabinet Power", "Cabinet Cooling", and "Pricing". Each section contains numerical values that may represent estimates generated by the tool based on the input parameters. These values may provide planners with quantitative data to assess the viability of the proposed cell site configuration.

Above the output panel, a text box 306 displays the words "Feasible Configuration". This label may quickly communicate to users that the current set of inputs has resulted in a viable cell site plan according to the tool's calculations and predefined constraints. In the remaining portion of the left panel, a simplified side view of a cell site cabinet 308 is shown. Adjacent to this cabinet representation, a large checkmark symbol 310 is visible. This checkmark may serve as an additional visual cue reinforcing the feasibility of the configuration, potentially enabling users to quickly grasp the overall status of their planning scenario at a glance.

The right panel of FIG. 3 mirrors the layout of the left panel, using the same reference numbers for identical elements (302, 304, 306, 308). However, this panel illustrates an infeasible configuration scenario. The output panel 304 in this case displays a different set of numerical values, which may represent estimates that fall outside acceptable ranges or violate certain constraints defined within the tool. The border surrounding the output panel sections in this infeasible scenario uses a different line pattern, such as dashed lines, to visually distinguish it from the feasible configuration.

The text box 306 in the right panel reads "Infeasible Configuration", clearly indicating that the current set of inputs has resulted in a cell site plan that may not be viable or may violate certain constraints. Next to the cell site cabinet representation 308 in this panel, a large X symbol 312 is shown instead of a checkmark. This X symbol may serve as an immediate visual indicator that the configuration is not feasible, potentially alerting users to the need for adjustments in their planning parameters.

In some examples, the cell planning software tool may employ color-coding to further enhance the visual distinction between feasible and infeasible configurations. While the figure uses different line patterns to represent this distinction due to patent drawing restrictions, in practice, the tool's interface may use colors such as green for feasible configurations and red for infeasible ones. This color-coding may provide an additional layer of intuitive feedback to users, potentially enabling for quick and easy interpretation of results even when dealing with complex datasets or multiple planning scenarios.

The side-by-side presentation of feasible and infeasible configurations in FIG. 3 may illustrate the tool's capability to provide clear, visual feedback on the viability of different cell site planning scenarios. This comparative view may enable planners to quickly identify when their input parameters result in a workable configuration and when adjustments may be needed. The use of consistent layout and elements across both panels, with clear visual distinctions for feasibility status, may potentially enhance the user's ability to interpret and compare different planning scenarios efficiently.

In some examples, the output displayed in the panels of FIG. 3 may be dynamically updated as users adjust input parameters in the cell planning software tool. This real-time feedback may enable planners to iteratively refine their configurations, potentially observing how changes in factors such as cabinet type, cooling unit selection, or the number of distributed units affect the overall feasibility of the cell site plan. The clear visual indicators of feasibility status, combined with the specific numerical outputs for power, cooling, and pricing, may provide a comprehensive yet easily digestible summary of each configuration's viability.

In some scenarios, the cell planning software tool may provide additional details or explanations when a configuration is deemed infeasible, as illustrated in the right panel of FIG. 3. For instance, the tool may highlight specific output values that violate constraints, or provide textual explanations of why the configuration is not viable. This level of detail may potentially guide users towards making appropriate adjustments to their input parameters, facilitating a more efficient and educational planning process.

In some examples, the cell planning software tool may generate a detailed output report for a specific cell site configuration. This report may be labeled with parameters such as the cabinet type (e.g., "GREAT LAKES"), cooling system (e.g., "HVAC"), number of distributed units (DUs) and nodes (e.g., "3 DU(s) and 9 Node(s)"), support type (e.g., "Macro support"), and the type of distributed unit (e.g., "XR-11 DU"). The cabinet type may indicate a specific model or form factor designed for cellular equipment, which may influence the overall capacity and layout of the cell site. The cooling system specification may be important for maintaining operating temperatures, with HVAC systems potentially offering more precise temperature control compared to passive cooling solutions. The number of DUs and nodes may provide insight into the processing capacity and coverage capabilities of the site, with each DU potentially supporting multiple nodes. The macro support designation may indicate that the cabinet is configured to house equipment for a larger, high-capacity cell site, as opposed to a small cell or micro site. The distributed unit type may specify the particular model of baseband processing unit being used, which may have implications for compatibility, performance, and power consumption.

The output section of the report may be divided into three main categories: 5G Cabinet Power, 5G Cabinet Cooling, and Pricing. In the 5G Cabinet Power category, there may be two subtitles representing different traffic load scenarios. For the 75% traffic load scenario, the report might show a Current Max Load of 11,500W, a Current Power Load of 7215W, and a Spare Power Load Capacity of 4285W. These values may provide insight into the power utilization and remaining capacity of the cell site under typical operating conditions. The Current Max Load may represent the maximum power capacity of the cabinet or power supply system. The Current Power Load may indicate the estimated power consumption of all equipment at 75% of peak traffic, while the Spare Power Load Capacity might show the remaining available power for potential expansion or fluctuations in demand. For the 100% traffic load scenario, the report might display a Current Max Load of 11,500W, a Current Power Load of 9875W, and a Spare Power Load Capacity of 1625W. These values may illustrate how power consumption may increase under peak traffic conditions, potentially reducing the spare capacity for additional equipment or future upgrades.

The 5G Cabinet Cooling section may similarly present data for both 75% and 100% traffic load scenarios. In the 75% scenario, the report might show an HVAC Max Capacity of 1800W, an HVAC Current Load of 1785W, an HVAC Spare Capacity of 15W, and an HVAC Current Capacity of 0.15 tons. These values may provide information about the cooling system's capacity and utilization. The HVAC Max Capacity may represent the maximum cooling power of the installed system, while the Current Load may indicate the estimated cooling required at 75% traffic. The Spare Capacity might show the remaining cooling power available, and the Current Capacity in tons may offer an alternative measure of cooling performance. For the 100% traffic load scenario, the report might display an HVAC Max Capacity of 1800W, an HVAC Current Load of 2150W, an HVAC Spare Capacity of -350W, and an HVAC Current Capacity of 0.18 tons. The negative Spare Capacity value in this scenario may indicate that the cooling requirements at peak traffic exceed the system's capabilities, potentially highlighting a need for upgraded cooling or load reduction strategies.

In some examples, the cell planning software tool may use color-coding to indicate the feasibility of various parameters within the configuration. While FIG. 3 illustrates a binary feasible/infeasible distinction, in practice, the tool may employ a more nuanced technique. For instance, most values in the example output might be displayed in green, indicating that they fall within acceptable ranges. However, specific values that exceed thresholds or indicate potential issues, such as the negative HVAC Spare Capacity at 100% traffic load, might be highlighted in red. This granular technique to feasibility indication may enable planners to quickly identify specific areas of concern within an otherwise viable configuration, potentially enabling more targeted optimization efforts.

The concept of granular feasibility may be further expanded beyond a simple green/red dichotomy. In some embodiments, the cell planning software tool may employ a more sophisticated color scale or gradient to represent varying degrees of feasibility or optimization. For example, dark green might indicate optimal values, light green for acceptable but not ideal, yellow for borderline acceptable, orange for potential concerns, and red for important issues. This multi-tiered technique may provide users with a more nuanced understanding of their cell site configuration's performance across various parameters. Additionally, the tool might use numerical scores or percentages to quantify feasibility, enabling for more precise comparisons between different configurations or parameters. This granular technique to feasibility assessment may potentially enable more informed decision-making and facilitate the identification of configurations that are not just feasible, but optimal for specific deployment scenarios.

While the example output includes fields for power, cooling, and basic pricing information, In some example embodiments, the cell planning software tool incorporates a wide range of additional parameters and metrics to provide a more comprehensive analysis. For instance, the tool might include fields for radio frequency (RF) performance metrics such as coverage area, capacity, and expected data rates. It may also incorporate more detailed financial analysis, including operational expenses (OPEX) projections, return on investment (ROI) calculations, and total cost of ownership (TCO) over the life of the cell site. Environmental impact assessments may be added, potentially including fields for carbon footprint, noise levels, and visual impact scores. The tool might also include fields for reliability metrics, such as estimated mean time between failures (MTBF) and availability percentages. Regulatory compliance indicators may be incorporated, showing adherence to local zoning laws, emission standards, and other relevant regulations. Additionally, the tool may include fields for future-proofing assessments, indicating the ease of upgrading or expanding the site to accommodate new technologies or increased capacity demands.

The detailed output described in this example may be seen as an extension of the concept illustrated in FIG. 3. While FIG. 3 provides a high-level, visual representation of feasible and infeasible configurations, the detailed output report offers a more granular and quantitative view of the same underlying analysis. The color-coding used in the detailed output aligns with the visual indicators in FIG. 3, but provides a more nuanced representation of feasibility across multiple parameters. This detailed output may be thought of as the underlying data that informs the simplified visual representation in FIG. 3, enabling users to drill down into specific aspects of the configuration when needed. The combination of high-level visual indicators and detailed quantitative data may provide users with a comprehensive tool for cell site planning, enabling both quick assessments and in-depth analysis as required for different planning scenarios or stages of the deployment process.

To summarize, in some examples, the cell planning software tool may automatically suggest the nearest feasible configuration when the initial estimate indicates an infeasible configuration. This feature may involve adjusting one or more input parameters to find a viable alternative that closely matches the original input. The tool might employ optimization algorithms to identify which parameters to adjust and by how much, potentially considering factors such as the relative importance of different parameters and the sensitivity of the overall configuration to changes in each parameter. Once a feasible configuration is identified, the tool may output this suggestion through its interface, possibly highlighting the changes made from the original input. This functionality may significantly streamline the iterative process of finding a workable cell site configuration, potentially saving time and reducing the likelihood of overlooking viable options.

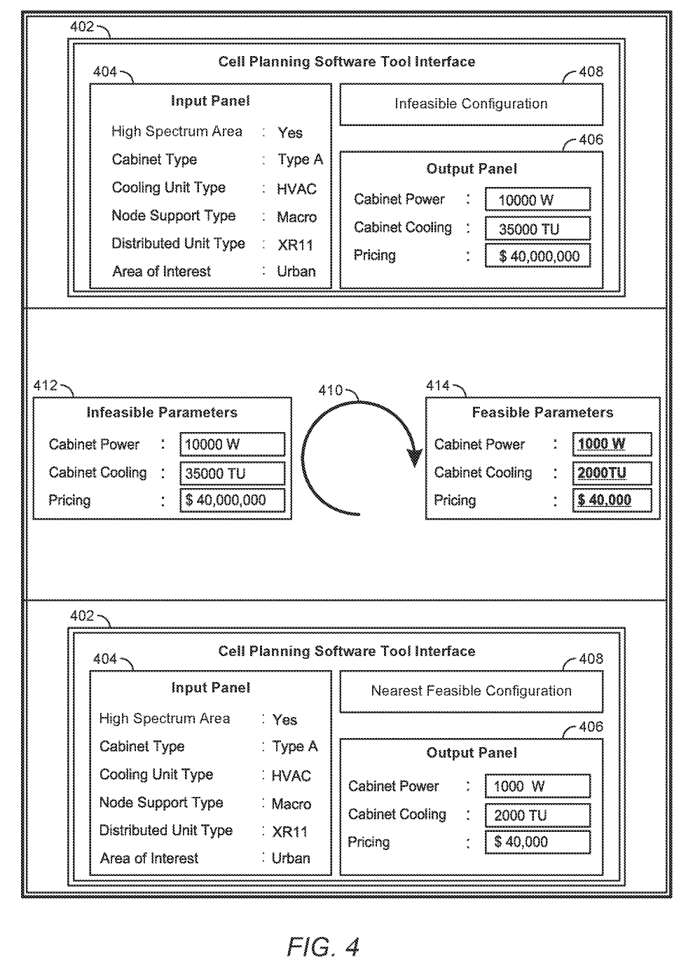

FIG. 4 illustrates an example of how the cell planning software tool may suggest the nearest feasible configuration when an infeasible configuration is input. The figure is divided into three panels arranged vertically, each representing a different stage in the process of finding a feasible configuration.

The top panel of FIG. 4 shows a rectangular frame 402 representing a computer screen displaying the cell planning software tool interface with an infeasible configuration. Within this frame, an input panel 404 is visible on the left side, presenting six distinct fields that correspond to parameters in cell site planning. These fields may include options for specifying a high spectrum area indication, selecting a cabinet type, choosing a cooling unit type, determining the node support type, specifying the distributed unit type, and designating an area of interest. In this example, the input panel 404 may show values that, when combined, result in an infeasible configuration. On the right side of the screen, an output panel 406 may be seen, which may display estimated values for cabinet power, cabinet cooling, and pricing. These values may be color-coded or otherwise visually indicated to show that they fall outside acceptable ranges or violate certain constraints. Above the output panel, a text box 408 displays the message "Infeasible Configuration," indicating that the current set of inputs has resulted in a cell site plan that may not be viable.

In some examples, the cell planning software tool may employ sophisticated algorithms to analyze the infeasible configuration and determine which parameters may be adjusted to achieve feasibility. This process may involve evaluating the sensitivity of the output to changes in each input parameter, identifying which adjustments would have the most significant impact on feasibility, and considering any interdependencies between parameters. The tool may prioritize changes that minimize deviation from the original configuration while still achieving feasibility, potentially balancing factors such as performance, cost, and practical implementation constraints.

The middle panel of FIG. 4 illustrates the suggestion process through which the cell planning software tool may identify the nearest feasible configuration. A large circular arrow 410 pointing downward may be seen in the center of this panel, visually representing the process of transforming the infeasible configuration into a feasible one. On the left side of the arrow, a list of the original infeasible parameters 412 from the top panel may be displayed. These parameters may serve as a reference point, enabling users to easily compare the initial configuration with the suggested adjustments. On the right side of the arrow, a list of adjusted parameters 414 that may lead to a feasible configuration may be shown. The changes in these parameters may be highlighted with asterisks or underlining to draw attention to the specific modifications suggested by the tool.

In some scenarios, the cell planning software tool may generate multiple feasible configuration options, each representing a different technique to resolving the infeasibility. For instance, one suggestion might prioritize minimal changes to the physical infrastructure, while another might focus on optimizing power efficiency or minimizing costs. The tool may rank these suggestions based on various criteria such as ease of implementation, cost-effectiveness, or alignment with predefined planning priorities. This multi-option technique may provide planners with flexibility in choosing the most appropriate solution for their specific circumstances.

The bottom panel of FIG. 4 presents the nearest feasible configuration as determined by the cell planning software tool. This panel mirrors the layout of the top panel, using the same reference numbers for identical elements (402, 404, 406, 408). The input panel 404 in this section shows the adjusted parameters from the middle panel, reflecting the changes suggested by the tool to achieve feasibility. The output panel 406 may display numerical values that now fall within acceptable ranges, potentially color-coded or visually indicated to show their feasibility. The text box 408 in this panel is updated to read "Nearest Feasible Configuration," signaling that the adjustments have resulted in a viable cell site plan.

In some examples, the cell planning software tool may provide additional context or explanations for the suggested changes. This information may be displayed in pop-up windows, tooltips, or an additional panel within the interface. Such explanations may help users understand the rationale behind each adjustment, potentially including information about the constraints that were violated in the original configuration and how the suggested changes address these issues. This level of transparency in the suggestion process may help planners make more informed decisions and potentially learn from the tool's analysis to improve their future planning efforts.

The automatic suggestion feature illustrated in FIG. 4 may significantly streamline the cell planning process by rapidly identifying viable configurations. This capability may be particularly valuable in complex planning scenarios where manual adjustment of multiple interdependent parameters may be time-consuming and error-prone. By quickly suggesting feasible alternatives, the tool may potentially reduce the iterative cycle time in cell site planning, enabling planners to explore a wider range of options and optimize their designs more efficiently.

In some embodiments, the cell planning software tool may enable users to interact with the suggestion process, potentially enabling them to set priorities or constraints for the adjustments. For example, users might be able to specify certain parameters as fixed or define acceptable ranges for others. This interactive technique may combine the computational power of the tool with the domain expertise of human planners, potentially leading to more nuanced and context-appropriate solutions. The tool may also provide sensitivity analysis, showing how small changes in various parameters affect the overall feasibility and performance of the configuration. This information may help planners understand the robustness of different configurations and make more informed decisions about trade-offs between various factors.

The nearest feasible configuration suggestion feature may be particularly valuable in scenarios where planners are working with tight constraints or trying to optimize multiple competing factors. For instance, in urban environments where space is at a premium and regulatory restrictions are stringent, finding a feasible configuration that meets all requirements may be challenging. The tool's ability to quickly suggest viable alternatives may help planners navigate these complex scenarios more effectively. Similarly, when deploying cell sites in remote or challenging environments, where factors such as power availability or climatic conditions may impose strict limitations, the suggestion feature may help identify creative solutions that might not be immediately apparent to human planners.

In some examples, the cell planning software tool may extend the concept of nearest feasible configuration to include optimization capabilities. Rather than simply finding a configuration that meets the minimum criteria for feasibility, the tool may suggest options that optimize certain parameters while maintaining feasibility. For instance, it might propose configurations that minimize power consumption, maximize coverage area, or reduce overall costs. This optimization capability may help planners not just achieve feasible designs, but identify the most efficient and effective configurations for their specific needs and constraints.

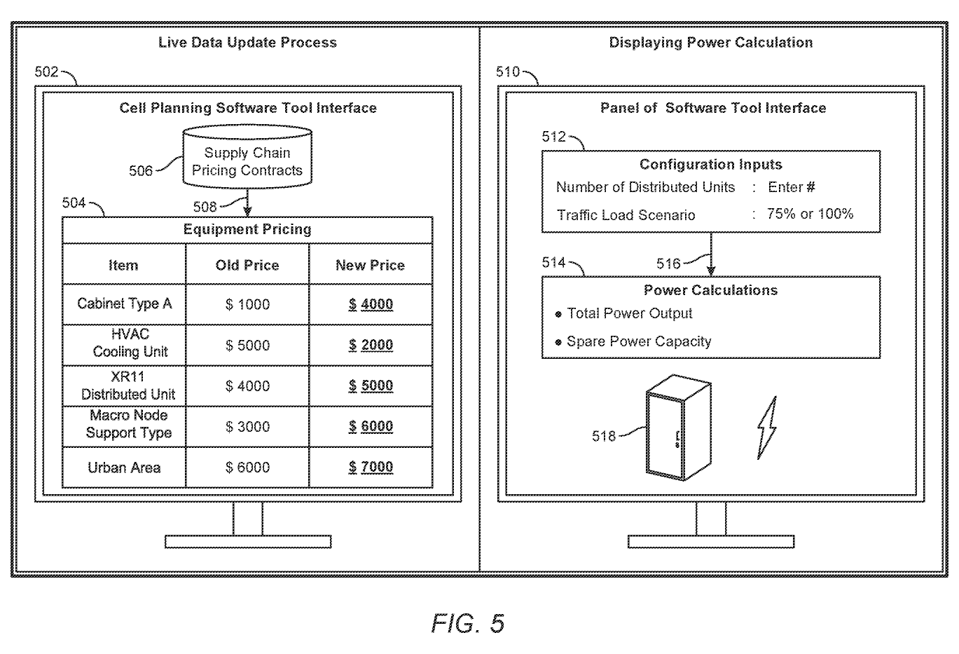

FIG. 5 depicts an example of live data updates and power calculations performed by the cell planning software tool. The figure is divided into two main sections: a left section showing the live data update process, and a right section displaying power calculations.

The left section of FIG. 5 features a large rectangular frame 502 representing a computer screen displaying the cell planning software tool interface. This frame occupies approximately two-thirds of the left section's width. Within the screen, a table 504 labeled "Equipment Pricing" is prominently displayed. The table consists of three columns: "Item," "Old Price," and "New Price." At least five rows are included in the table, each representing different equipment items that may be relevant to cell site planning. These items may include examples such as various cabinet types, cooling unit models, or distributed unit specifications. The "Old Price" column contains placeholder prices that may represent previously stored or default values in the system.

Above the pricing table, a small icon 506 is visible. This icon may represent a database or cloud storage system. It is labeled "Supply Chain Pricing Contracts," indicating one potential source of the live pricing data. An arrow 508 extends from this icon to the pricing table, visually representing the flow of real-time data updates from the supply chain pricing contracts to the cell planning software tool's interface. This arrow emphasizes the dynamic nature of the pricing information and its integration into the planning process.

In the "New Price" column of the table, updated prices are shown. Some of these prices may visibly differ from the corresponding values in the "Old Price" column. The cells containing updated prices are distinguished by a distinct line style, such as bold or double lines. This visual differentiation may help users quickly identify which equipment items have experienced recent price changes, potentially influencing their planning decisions.

In some examples, the cell planning software tool may incorporate live data updates from supply chain pricing contracts into its underlying calculation values. This feature may enable planners to work with the most current pricing information, potentially leading to more accurate cost estimations and budget planning. The tool may periodically query the supply chain database for updates, or it may establish a real-time connection that pushes updates as soon as they occur. The frequency of these updates may be configurable, enabling organizations to balance the need for current data with system performance considerations.

In some examples, the cell planning software tool may incorporate live data updates from a variety of sources, not limited to supply chain pricing contracts. While these contracts may provide valuable, up-to-date pricing information directly from equipment manufacturers or distributors, they may represent just one facet of a more comprehensive data update system. The tool may also interface with public or subscription-based pricing databases that aggregate information from multiple vendors, potentially offering a broader view of market trends and competitive pricing. Web scraping techniques may be employed to gather pricing data from manufacturer websites, online marketplaces, or industry publications, with the tool potentially using sophisticated algorithms to verify and normalize this information. Electronic data interchange (EDI) systems might be utilized to automatically receive updates from partner organizations in standardized formats. The tool may potentially connect to internal enterprise resource planning (ERP) systems to access the most current negotiated prices and volume discounts specific to the organization. Email integration might enable the tool to process price update notifications sent by vendors, automatically extracting and incorporating new pricing data. Industry-specific trading networks or B2B platforms may serve as another source of real-time pricing information. Additionally, the tool might leverage application programming interfaces (APIs) provided by equipment manufacturers or industry consortia to access pricing data programmatically.

Beyond pricing updates, the cell planning software tool may incorporate live data for a wide range of parameters that may influence cell site planning and operations. For instance, the tool may integrate real-time spectrum availability data from regulatory databases, enabling planners to work with the most up-to-date information on frequency allocations and licensing in different regions. Local power grid data may be incorporated, providing insights into electricity costs, reliability, and peak usage times, which may influence decisions about power systems and backup solutions. The tool might access live weather data and climate projections, factoring environmental conditions into cooling requirements and equipment specifications. Traffic data from existing network infrastructure may be fed into the tool, enabling more accurate capacity planning based on current usage patterns and trends. The tool may update its database of equipment specifications in real-time as manufacturers release new products or firmware updates, ensuring that planners always have access to the latest technology options. Regulatory compliance requirements may be dynamically updated in the tool as new laws or industry standards are introduced. The tool might also incorporate live data on construction costs, labor rates, and material availability in different regions, which may significantly impact overall project budgets. Geospatial data updates may be integrated, providing current information on land use, building heights, and other factors affecting radio frequency propagation models. The tool may potentially access real-time network performance data from operational sites, using this information to refine its predictive models and optimization algorithms. Additionally, the tool might incorporate live updates on technology trends, such as the adoption rates of new wireless standards or emerging use cases, to help planners future-proof their designs.

The right section of FIG. 5 displays another rectangular frame 510, representing a second screen or panel of the cell planning software tool. Within this frame, two sub-sections are visible: an input area 512 and an output area 514. The input area 512 is labeled "Configuration Inputs" and includes fields for "Number of Distributed Units" and "Traffic Load Scenario." The Traffic Load Scenario field may offer options for 75% and 100% capacity, enabling planners to consider different operational conditions.

The output area 514 is labeled "Power Calculations" and displays fields for "Total Power Output" and "Spare Power Capacity." These fields may provide important information about the power requirements and available capacity for the proposed cell site configuration. An arrow 516 points from the input area to the output area, visually representing the calculation process that transforms the input parameters into power-related outputs.

Below the frames, a simplified diagram of a cell site cabinet 518 is shown. A power symbol or lightning bolt icon is placed next to this cabinet representation, visually tying the abstract power calculations to a tangible, real-world component of the cell site. This visual element may help users contextualize the power-related data and better understand its practical implications in the field.

In some examples, the cell planning software tool may calculate power output and spare power capacity based on the input parameters. These calculations may take into account factors such as the number of distributed units, the expected traffic load, and the specifications of the selected equipment. The tool may use complex algorithms that consider the power consumption characteristics of various components under different operational conditions. For instance, it may account for the non-linear relationship between traffic load and power consumption, where doubling the traffic may not necessarily double the power requirements due to efficiencies in modern equipment designs.

The ability to calculate power requirements for different traffic load scenarios, such as 75% and 100% capacity, may be particularly valuable for planners. It may enable them to design cell sites that may handle peak traffic conditions while also understanding the typical operating conditions. This information may be helpful for optimizing energy efficiency and planning for future capacity expansions. The tool may also use these calculations to provide recommendations for power supply specifications, backup power requirements, or energy-saving strategies.

In some examples, the cell planning software tool may offer flexibility in defining and analyzing traffic load scenarios beyond the 75% and 100% thresholds shown in the figure. These percentages may be considered illustrative examples, and the tool may enable users to input custom load values tailored to their specific planning needs. For instance, planners might want to examine scenarios at 50%, 80%, or 120% of projected peak load to account for various operational conditions or future growth projections. The tool may potentially display calculations for multiple load scenarios simultaneously, enabling side-by-side comparisons of power requirements, cooling needs, and other relevant parameters across different usage levels. This multi-scenario technique may help planners design cell sites that may efficiently handle a range of traffic conditions, from typical daily operations to occasional surge events or long-term capacity expansions. The ability to customize and compare multiple load scenarios may provide a more nuanced understanding of a cell site's performance and resource requirements under various conditions, potentially leading to more robust and adaptable network designs.

In some scenarios, the cell planning software tool may extend its power calculations to include more detailed analysis. For example, it might provide breakdowns of power consumption by component type (e.g., radio units, cooling systems, baseband processing units) or estimate daily and seasonal power consumption patterns based on historical traffic data for the area of interest. The tool may potentially incorporate local electricity pricing data to estimate operational costs under different usage scenarios. It might also calculate the carbon footprint associated with the power consumption, aligning with growing interests in sustainable network deployments.

The combination of live pricing updates and detailed power calculations, as illustrated in FIG. 5, may significantly enhance the accuracy and relevance of cell site planning. By working with current pricing data, planners may make more informed decisions about equipment selection and budget allocation. The power calculations may help ensure that proposed configurations are not only feasible from a technical standpoint but also optimized for energy efficiency and operational costs. This integrated technique to data management and analysis may potentially lead to more cost-effective and sustainable cell site deployments.

In some examples, the cell planning software tool may enable users to perform sensitivity analyses based on the live pricing updates and power calculations. Planners may explore how potential future price changes might impact the overall cost of different configuration options. Similarly, they might investigate how variations in power consumption or electricity prices may affect the long-term operational expenses of the cell site. This forward-looking capability may help organizations make more resilient planning decisions, potentially reducing the risk of cost overruns or suboptimal configurations due to changing market conditions.

In some examples, the cell planning software tool may initially be implemented using spreadsheet software with macro capabilities, such as Excel, to provide a familiar and accessible interface for users. This technique may leverage the built-in functions and data manipulation features of spreadsheet applications, enabling for rapid prototyping and deployment of the tool. Macros may be utilized to automate complex calculations, data retrieval, and report generation, potentially enhancing the tool's functionality beyond basic spreadsheet operations. However, as the tool's complexity and functionalities grow, more sophisticated data processing applications may be employed. For instance, business intelligence platforms like Tableau may be integrated to provide advanced data visualization and interactive reporting capabilities. These platforms may offer more robust data connection options, enabling the tool to interface with a wider range of data sources and perform more complex analyses. In some scenarios, the tool may evolve to incorporate elements of data warehousing, potentially using extract, transform, load (ETL) processes to gather and standardize data from diverse sources. Online analytical processing (OLAP) techniques may be applied to enable multidimensional analysis of cell site planning data. The tool may also leverage database management systems (DBMS) to handle larger volumes of data more efficiently, potentially using structured query language (SQL) for data retrieval and manipulation. In more advanced implementations, the tool may incorporate elements of big data analytics, possibly using frameworks like Hadoop or Spark to process and analyze vast amounts of network planning and performance data. Data mining techniques may be employed to uncover patterns and insights that may inform planning decisions. The tool might also utilize application programming interfaces (APIs) to facilitate real-time data exchange with external systems, such as equipment manufacturer databases or regulatory information sources. Web scraping methods, including parsing of HTML and XML data, may be used to gather information from online sources automatically. As the tool evolves, it may incorporate machine learning algorithms to enhance its predictive capabilities, potentially using techniques such as regression analysis or neural networks to forecast network performance and optimize planning recommendations.

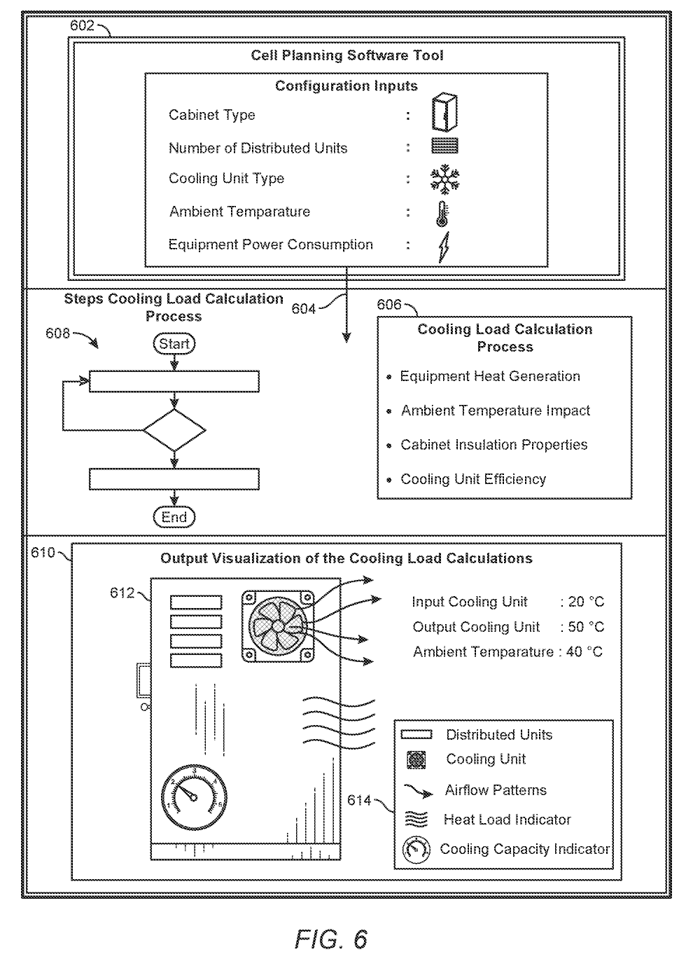

FIG. 6 shows an example of cooling load calculations and visualization provided by the cell planning software tool. The figure is divided into three main sections: an input section at the top, a calculation section in the middle, and a visualization section at the bottom.

The top section of FIG. 6 displays a rectangular frame 602 that represents the input interface of the cell planning software tool. Within this frame, an input panel is visible, presenting several fields that are helpful for cooling load calculations. Each field is accompanied by a small icon or symbol to provide visual representation. The fields include Cabinet Type, which is represented by a small cabinet outline icon; Number of Distributed Units, symbolized by a stack of rectangular units; Cooling Unit Type, which is depicted by a snowflake icon; Ambient Temperature, which is represented by a thermometer icon; and Equipment Power Consumption, which is illustrated by a lightning bolt icon. These input fields may enable users to specify the key parameters that influence cooling requirements for a cell site. The section is "Configuration Inputs" in a bold font, emphasizing its role in the cooling load calculation process.

Below the input section, a large arrow 604 points downward, visually representing the flow of information from the inputs to the calculation process. To the right of this arrow, a text box 606 labeled "Cooling Load Calculation Process" is visible. This text box contains a list of factors that may be considered in the cooling load calculation. These factors may include equipment heat generation, ambient temperature impact, cabinet insulation properties, and cooling unit efficiency. By presenting these factors, the tool may provide users with insight into the complexity of the cooling load calculation and the various elements that contribute to the overall cooling requirements of a cell site.

To the left of the large arrow 604, a simplified flowchart 608 illustrates the steps of the cooling load calculation process. This flowchart may use generic process shapes such as rectangles for processes and diamonds for decisions, providing a visual representation of the logical flow of the calculation. The inclusion of this flowchart may help users understand the sequence of operations performed by the tool to determine cooling requirements, potentially enhancing their comprehension of the underlying methodology.

The bottom section of FIG. 6 features a large rectangular frame 610 that represents the output visualization of the cooling load calculations. Within this frame, a detailed side view of a cell site cabinet 612 is prominently displayed. This cabinet representation serves as the canvas for visualizing various aspects of the cooling load calculation results.

Inside the cabinet representation 612, several elements are illustrated to depict the components and processes relevant to cooling. Distributed units are shown as rectangular boxes within the cabinet, representing the heat-generating equipment. A cooling unit is depicted using a fan or coil symbol, indicating the primary means of heat removal. Airflow patterns within the cabinet are visualized using arrows to show air circulation, helping users understand how heat is managed within the confined space of the cabinet.

Around the cabinet representation, additional elements provide context and quantitative information related to the cooling load calculations. Temperature readings are displayed at various points, such as at the input and output of the cooling unit and the ambient temperature outside the cabinet. These temperature indicators may help users understand the thermal gradients within the system. Heat load indicators, represented by wavy lines emanating from equipment, may visually convey the relative heat generation of different components. A cooling capacity indicator, such as a gauge or meter, is included to show the current cooling load relative to the maximum cooling capacity of the system.

In one corner of the visualization frame, a small legend 614 is provided to explain the symbols used in the cooling load visualization. This legend may help users interpret the various visual elements and understand the quantitative information presented in the diagram.

In some examples, the cell planning software tool may perform cooling load calculations using equipment specifications indicated by the input parameters. These calculations may take into account a wide range of factors that influence cooling requirements in a cell site environment. For instance, the tool may consider the heat generation characteristics of specific models of distributed units, factoring in variables such as processing load and power efficiency. The impact of ambient temperature on cooling efficiency may be modeled, potentially incorporating historical climate data for the specified area of interest. Cabinet insulation properties may be included in the calculations, accounting for heat transfer through the cabinet walls and any passive cooling features.

The cooling unit type selected in the input may significantly influence the cooling load calculations. Different cooling technologies, such as direct air cooling, liquid cooling, or heat exchanger systems, may have varying efficiencies and capacities. The tool may incorporate detailed performance curves for different cooling unit models, enabling for accurate estimation of cooling capacity under various conditions. Factors such as airflow rates, coolant properties, and heat exchanger effectiveness may be considered in these calculations.

In some scenarios, the cell planning software tool may extend its cooling load calculations to include more advanced considerations. For example, it might model the impact of equipment layout within the cabinet on airflow and heat distribution. The tool may potentially simulate different airflow patterns to optimize component placement for maximum cooling efficiency. Thermal modeling techniques might be employed to predict hot spots within the cabinet and suggest mitigation strategies. The tool may also consider the impact of altitude on cooling performance, adjusting calculations for reduced air density at higher elevations.

The visualization provided in the bottom section of FIG. 6 may serve as a tool for understanding and communicating the results of cooling load calculations. By presenting the information in a graphical format that mimics the physical layout of a cell site cabinet, the tool may help users intuitively grasp the thermal dynamics at play. The visual representation of airflow patterns, temperature gradients, and heat loads may potentially highlight issues or opportunities that might be less apparent in purely numerical outputs.

In some examples, the cooling load visualization may be interactive, enabling users to explore different aspects of the thermal environment within the cabinet. Users might be able to hover over different components to see detailed temperature and heat generation data, or toggle between different viewing modes to focus on specific aspects of the cooling system. The tool may potentially offer the ability to animate airflow patterns or temperature changes over time, providing insight into the dynamic nature of cooling in a functioning cell site.

The combination of detailed input options, comprehensive calculations, and intuitive visualization in FIG. 6 illustrates the potential of the cell planning software tool to provide in-depth analysis of cooling requirements. This capability may be important for ensuring that cell sites are designed with adequate thermal management, potentially leading to improved equipment reliability, longer component lifespans, and more energy-efficient operations. By enabling planners to easily assess and optimize cooling solutions, the tool may contribute to more robust and cost-effective cell site designs.

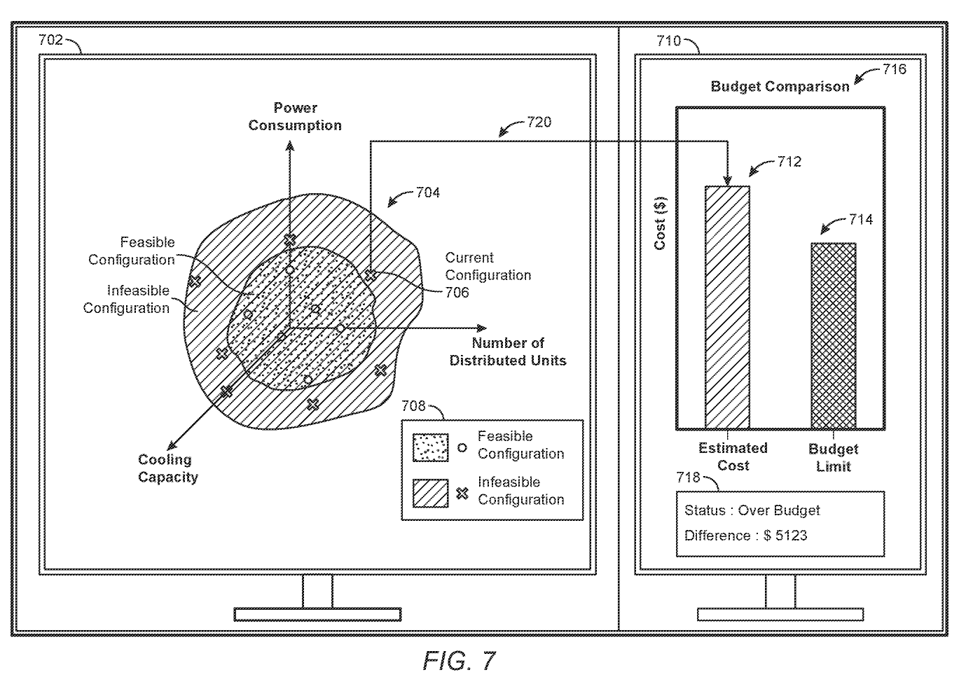

FIG. 7 illustrates an example multi-dimensional feasibility visualization and budget comparison output by the cell planning software tool. The figure is divided into two main sections: a left section for the multi-dimensional graph and a right section for the budget comparison. The left section of FIG. 7 features a large rectangular frame 702 representing a computer screen displaying the multi-dimensional graph. This frame occupies approximately two-thirds of the overall figure width. Within this frame, a three-dimensional graph is prominently displayed. The graph has three clearly labeled axes: the X-axis represents the Number of Distributed Units, the Y-axis represents Power Consumption, and the Z-axis represents Cooling Capacity. These three dimensions may enable users to visualize the complex interplay between key factors in cell site planning. The choice of these specific parameters for the axes may reflect their significance in determining the feasibility and efficiency of a cell site configuration. The Number of Distributed Units may directly impact the processing capacity and coverage capabilities of the site, while Power Consumption and Cooling Capacity are important factors in ensuring the reliable operation of the equipment and managing operational costs. By presenting these three factors in a three-dimensional space, the tool may enable planners to identify optimal configurations that balance performance requirements with resource constraints. The graph may also incorporate additional visual elements to represent other relevant factors, such as color coding to indicate signal strength or coverage area, potentially enabling for the simultaneous consideration of multiple parameters beyond the three primary axes.

On this three-dimensional graph, a surface 704 is plotted that represents the feasibility boundary. This surface divides the graph into two distinct regions. The region below or inside the surface is labeled "Feasible Configuration" and may be indicated using a dotted fill pattern. This area represents combinations of distributed units, power consumption, and cooling capacity that result in viable cell site configurations. The region above or outside the surface is labeled "Infeasible Configuration" and may be shown using a cross-hatch fill pattern. This area represents combinations that exceed the limitations or constraints of the system. The shape and position of this feasibility surface may provide valuable insights into the relationships between the different parameters and their impact on overall system viability. For example, a steep slope in one area of the surface might indicate a rapid transition from feasible to infeasible configurations as one parameter changes, suggesting a important constraint in that dimension. Conversely, a relatively flat area of the surface may indicate a range of configurations with similar feasibility, potentially offering flexibility in design choices. The tool may enable users to interact with this surface, possibly by rotating the view or selecting specific points to see detailed information about the constraints at that location. In some embodiments, the feasibility surface might be dynamic, updating in real-time as users adjust other parameters not represented in the three primary axes, such as cabinet type or cooling unit specifications.

Several points are plotted on the graph to illustrate specific configurations. Small circles may be used to represent feasible configurations, while small X marks may indicate infeasible configurations. One point near the feasibility boundary is specifically labeled as "Current Configuration" 706. This point may represent the cell site configuration currently under consideration or analysis. The distribution of these points across the graph may provide a visual representation of the exploration process in cell site planning. Clusters of points might indicate areas of particular interest or concern, while isolated points may represent unique or experimental configurations. The tool may enable users to interact with these points, possibly by hovering over them to see detailed specifications or clicking to load that configuration into the main interface for further analysis. The "Current Configuration" point 706 may be particularly significant, serving as a reference point for comparison with other potential configurations. Its proximity to the feasibility boundary may indicate a configuration that maximizes certain parameters while remaining within acceptable limits, or it might suggest an opportunity for optimization if it is well within the feasible region.

In one corner of the graph, a small legend 708 is provided to explain the symbols and patterns used in the visualization. This legend may help users interpret the various elements of the graph and understand the significance of different regions and data points. The inclusion of a clear and comprehensive legend is helpful for ensuring that users may accurately interpret the complex information presented in the multi-dimensional graph. It may include explanations of color coding schemes, point symbols, and surface patterns, as well as any additional visual cues used in the graph. In some embodiments, this legend might be interactive, enabling users to toggle different elements on and off to focus on specific aspects of the visualization. The legend may also include brief explanations of concepts or constraints represented in the graph, serving as a quick reference for users as they explore different configurations.

The right section of FIG. 7 contains another rectangular frame 710 representing a separate panel of the software tool. Within this frame, a vertical bar graph is displayed to facilitate budget comparison. The Y-axis of this graph is labeled "Cost ($)" to clearly indicate the financial scale being represented. The bar graph consists of two bars side by side. One bar is labeled "Estimated Cost" 712 and may represent the projected expenses for the current cell site configuration. The other bar is labeled "Budget Limit" 714 and may indicate the maximum allowable spending for the project. These two bars placed in close proximity may enable for easy visual comparison between the estimated costs and the budgetary constraints. This direct juxtaposition of estimated costs and budget limits may provide an immediate and intuitive understanding of the financial feasibility of a given configuration. The tool may use sophisticated cost modeling algorithms to generate the estimated cost, potentially considering factors such as equipment prices, installation costs, operational expenses, or even long-term maintenance projections. The budget limit may be a user-defined input or may be dynamically calculated based on various financial parameters and organizational policies. In some embodiments, the tool might offer the ability to break down the cost bar into different categories (e.g., hardware, software, installation, operational) to provide a more detailed view of the cost structure.

Above the bar graph, a text box 716 is prominently displayed with the label "Budget Comparison" in a clear, bold font. This label may help users quickly identify the purpose of this section of the visualization. Below the bar graph, a small panel 718 is included to provide additional context for the budget comparison. This panel may show information such as "Status: Over Budget" (assuming the estimated cost exceeds the budget limit in this example) and "Difference: $X,XXX" (where X,XXX represents a sample value indicating the amount by which the estimated cost exceeds or falls short of the budget limit). This additional information may offer a more nuanced view of the budget situation, potentially helping planners make informed decisions about whether a slight budget overage might be acceptable given the benefits of a particular configuration. The tool might also provide options to adjust the budget limit or explore cost-saving measures, with the visualization updating in real-time to reflect these changes. In some scenarios, the tool may offer predictive analytics, suggesting how future market trends or technology advancements might impact the cost-effectiveness of the current configuration over time.

An arrow 720 extends from the "Current Configuration" point on the multi-dimensional graph to the "Estimated Cost" bar in the budget comparison. This arrow visually links the two sections of the figure, emphasizing the relationship between the technical configuration represented in the 3D graph and its financial implications shown in the budget comparison. This visual connection may be particularly valuable in helping users understand the cost implications of technical decisions. As users explore different points on the feasibility surface, they may see real-time updates to the budget comparison, enabling for a dynamic exploration of the trade-offs between technical capabilities and financial constraints. In some embodiments, this link might be bidirectional, enabling users to adjust the budget and see how it affects the range of feasible configurations in the technical space. This integrated technique to technical and financial planning may potentially lead to more holistic and optimized cell site designs, balancing performance requirements with economic realities.

For completeness, the disclosure also reveals and discusses the following related concepts. In some examples, the cell planning software tool may incorporate forecasting capabilities to predict future costs based on current trends in power consumption, equipment prices, or operational expenses. This predictive functionality may leverage historical data and apply statistical or machine learning techniques to extrapolate future cost scenarios. The tool might consider factors such as seasonal variations in power consumption, long-term trends in equipment pricing, or projected changes in operational costs due to technological advancements or regulatory changes. These forecasted future costs may be incorporated directly into the estimate provided by the tool, or they might be output separately, enabling planners to consider both current and projected expenses when making decisions. This forward-looking technique may enable more strategic long-term planning and potentially help identify configurations that are not only feasible now but also economically viable in the future.

In some examples, the cell planning software tool may integrate with a data visualization tool to generate an interactive report dashboard for the estimate. This integration may enhance the user's ability to interpret and analyze the complex data produced by the cell planning process. The interactive dashboard might include dynamic charts, graphs, and tables that update in real-time as users adjust input parameters or explore different scenarios. It may offer features such as drill-down capabilities for detailed information, comparison views for multiple configurations, or custom report generation. By leveraging advanced data visualization techniques, this feature may make it easier for stakeholders from various backgrounds to understand the implications of different cell site configurations, potentially facilitating more informed decision-making and better communication across teams. The visualizations of FIGS. 4, 6, and 7 may correspond to part or all of simplified versions of such interactive report dashboards.

In some examples, the cell planning software tool may check port availability in a Cell Site Router (CSR) based on the calculated number of distributed units and include this port availability information in the estimate. This feature may help ensure that the proposed configuration is feasible from a network connectivity perspective. The tool might maintain a database of CSR specifications, including the number and types of available ports for different models. By cross-referencing this information with the number of distributed units in the proposed configuration, the tool may identify potential bottlenecks or limitations in network connectivity. Including this port availability information in the estimate may alert planners to any appropriate upgrades in routing equipment or help them improve the distribution of units across available ports.

In some examples, the cell planning software tool may compare the generated estimate to predefined budget constraints and output a feasibility indication based on this comparison. This feature may provide an immediate assessment of whether a proposed configuration is financially viable within the organization's budget limitations. The tool might enable users to input budget thresholds or retrieve this information from connected financial planning systems. The feasibility indication may be a simple binary (feasible/infeasible) output or a more nuanced scale indicating degrees of alignment with budget constraints. This functionality may help streamline the decision-making process by quickly identifying configurations that meet both technical and financial requirements, potentially reducing the time spent on iterations and helping to align technical planning with financial planning early in the process.

In some examples, the cell planning software tool may be designed to handle a wide range of cabinet types, each with its own characteristics that may significantly impact cooling and power capacity calculations. For instance, the tool may incorporate detailed specifications for cabinet types such as Charles, Delta, Great Lakes, and Intercess, among others. These specifications may include factors such as internal volume, insulation properties, maximum equipment capacity, and built-in cooling capabilities. The tool may use these specifications to perform complex calculations that take into account the interactions between the chosen cabinet type and other input parameters. For example, a Delta cabinet might enable for greater cooling capacity, potentially supporting a larger number of distributed units or nodes compared to other cabinet types. The software may dynamically adjust its power and cooling calculations based on the selected cabinet type, potentially offering real-time feedback on how changing the cabinet selection impacts the overall feasibility of the cell site configuration. This level of detail in cabinet type handling may enable planners to make more informed decisions about equipment selection and site design, potentially optimizing for factors such as energy efficiency, equipment density, and scalability. The tool may also provide comparative analyses between different cabinet types for a given set of input parameters, enabling users to quickly assess the trade-offs between various options and select the most appropriate cabinet for their specific requirements and constraints.

In some scenarios, the cell planning software tool may serve as a central hub for information aggregation and analysis, effectively bridging the gap between multiple teams involved in the cell site planning process. This centralization feature may potentially reduce errors and inconsistencies that might otherwise arise from different teams working in isolation with their own methodologies and assumptions. For example, the tool may integrate inputs and constraints from RF engineers, network designers, construction managers, and financial planners into a unified platform. RF engineers might input coverage requirements and spectrum utilization plans, while network designers may specify equipment configurations and capacity needs. Construction managers may provide information on site limitations and installation constraints, and financial planners may input budget parameters and cost targets. By bringing all these diverse inputs together, the tool may be able to perform comprehensive analyses that take into account technical, practical, and financial considerations simultaneously. This integrated technique may potentially identify conflicts or incompatibilities between different team's requirements early in the planning process, enabling for quicker resolution and more efficient iteration. The centralized nature of the tool may also facilitate better communication between teams, as all stakeholders may potentially access the same set of data and analysis results, promoting a shared understanding of the project constraints and objectives.

In some examples, the cell planning software tool may incorporate sophisticated modeling of heat generation from various equipment components, with particular attention paid to high-heat-generating elements such as rectifiers in macro site support scenarios. The tool may maintain a database of heat generation profiles for different equipment types, including rectifiers of various capacities and efficiencies. When a user specifies a macro site support configuration, the software may automatically factor in the additional heat load from the rectifiers, which may be substantial compared to other components. This detailed heat modeling may enable the tool to more accurately calculate the total cooling requirements for the cell site. The software might also consider the placement of rectifiers within the cabinet, potentially simulating airflow patterns to identify potential hot spots or areas of thermal concentration. This level of detail in heat generation modeling may be helpful for ensuring that the cooling solution specified for the site is adequate to maintain all equipment within safe operating temperatures, even under peak load conditions. The tool may also use this heat generation data to inform power consumption estimates, as cooling systems may need to work harder in configurations with higher heat loads, potentially impacting the overall energy efficiency of the site.

In some scenarios, the cell planning software tool may provide detailed calculations and visualizations of HVAC spare capacity, including cases where this capacity might be negative. The tool may calculate HVAC spare capacity by subtracting the estimated cooling load of the configured equipment from the total cooling capacity of the specified HVAC system. This calculation might be performed for various traffic load scenarios, such as 75% and 100% of peak capacity. The software may present these results in a clear, easy-to-understand format, potentially using color-coding or other visual cues to quickly indicate whether the spare capacity is positive or negative. In cases where the calculated spare capacity is negative, the tool might highlight this as an issue, as it indicates that the cooling system may be inadequate for the proposed configuration. The software may potentially provide additional context in these scenarios, such as estimating the degree of overheating that might occur or suggesting the minimum cooling capacity upgrade required to achieve a positive spare capacity. This feature may be particularly valuable for planning future expansions or upgrades, as it may help users understand how much additional equipment may be added to the site before requiring cooling system enhancements. The tool might also offer optimization suggestions, such as recommending alternative equipment configurations or more efficient cooling solutions to increase spare capacity.

In some examples, the cell planning software tool may be capable of handling different distributed unit types, such as XR11 or Super Micro, and accurately modeling their impact on the overall processing capacity of the cell site. The tool may maintain a database of specifications for various distributed unit models, including details such as processing power, power consumption, heat generation, and maximum supported nodes. When a user selects a specific distributed unit type, the software may automatically adjust its calculations to reflect the capabilities or limitations of that particular model. For instance, the tool might recognize that an XR11 unit may support a larger number of nodes or handle higher data throughput compared to a Super Micro unit, despite the latter potentially having more processor cores. The software may use this information to calculate the maximum number of nodes that may be supported by the chosen configuration, taking into account factors such as processing capacity, power constraints, and cooling capabilities. This detailed modeling of distributed unit characteristics may enable the tool to provide more accurate estimates of cell site capacity and performance.

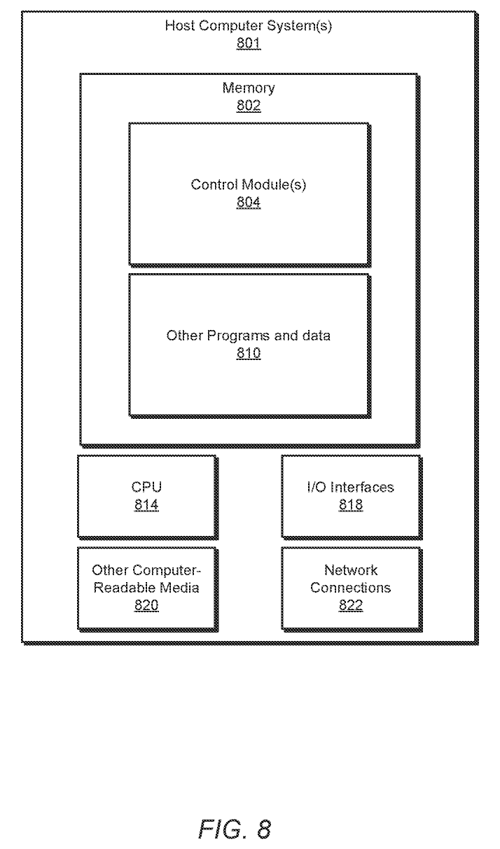

FIG. 8 shows a system diagram that describes an example embodiment of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 8 illustrates an example of underlying hardware on which such software and functionality may be hosted and/or implemented.

In particular, shown is example host computer system(s) 801. For example, such computer system(s) 801 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems or components described herein. Memory 802 may also store other programs and data 810, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, through a cell planning software tool, as a first input a respective value for each field in a set of fields comprising a high spectrum area indication, a cabinet type, a cooling unit type, a node support type, a distributed unit type, and an area of interest;
receiving, through the cell planning software tool, as a second value a specification of a number of distributed units or a number of nodes;
retrieving, by the cell planning software tool, in response to receiving the first input, underlying calculation values that match the first input for calculating cabinet power, cabinet cooling, or pricing;
outputting, through the cell planning software tool, an estimate of cabinet power, cabinet cooling, or pricing for a corresponding cell site that is based on an application to the second input of the underlying calculation values that were retrieved in response to receiving the first input; and
initiating building, in response to the cell planning software tool outputting the estimate, a corresponding cell site that conforms to the first input or the second input.

2. The method of claim 1, wherein outputting the estimate is conditioned upon receiving input for all six fields of the first input.

3. The method of claim 1, wherein outputting the estimate comprises color-coding the output based on feasibility.

4. The method of claim 3, wherein the color-coding comprises using green to indicate a feasible configuration or red to indicate an infeasible configuration.

5. The method of claim 1, further comprising:
automatically suggesting a nearest feasible configuration by adjusting an input parameter in response to the estimate indicating an infeasible configuration; and
outputting the nearest feasible configuration through the cell planning software tool.

6. The method of claim 1, wherein retrieving the underlying calculation values comprises incorporating a live data update for pricing information from a supply chain pricing contract.

7. The method of claim 1, wherein outputting the estimate comprises calculating and including power output or spare power capacity based on the first input and the second input.

8. The method of claim 1, wherein the underlying calculation values account for an accounted capacity scenario including a 75% capacity scenario or a 100% capacity scenario.

9. The method of claim 1, wherein outputting the estimate comprises performing a cooling load calculation using an equipment specification designated by the first input.

10. The method of claim 1, further comprising:
visualizing a feasible configuration in a multi-dimensional graph based on the first input and the second input; and
displaying the multi-dimensional graph through the cell planning software tool.

11. The method of claim 1, further comprising:
forecasting a future cost based on a current trend in power consumption, equipment prices, or operational expenses; and
incorporating the forecasted future cost into the estimate or outputting the forecasted future cost separately through the cell planning software tool.

12. The method of claim 1, further comprising:
integrating with a data visualization tool; and
generating an interactive report dashboard for the estimate through the data visualization tool.

13. The method of claim 1, wherein retrieving the underlying calculation values comprises automatically updating a seasonal power consumption trend.

14. The method of claim 1, wherein outputting the estimate comprises:
calculating a maximum number of nodes supported by a given number of distributed units based on the first input; and
including the calculated maximum number of nodes in the estimate.

15. The method of claim 1, wherein outputting the estimate comprises:
checking port availability in a Cell Site Router (CSR) based on the calculated number of distributed units; and
including the port availability information in the estimate.

16. The method of claim 1, further comprising:
comparing the estimate to predefined budget constraints; and
outputting a feasibility indication based on the comparison through the cell planning software tool.

17. A non-transitory computer-readable medium that has instructions stored thereon that, when executed by at least one physical computing processor, cause a computing device to perform operations comprising:
receiving, through a cell planning software tool, as a first input a respective value for each field in a set of fields comprising a high spectrum area indication, a cabinet type, a cooling unit type, a node support type, a distributed unit type, and an area of interest;
receiving, through the cell planning software tool, as a second value a specification of a number of distributed units or a number of nodes;
retrieving, by the cell planning software tool, in response to receiving the first input, underlying calculation values that match the first input for calculating cabinet power, cabinet cooling, or pricing;
outputting, through the cell planning software tool, an estimate of cabinet power, cabinet cooling, or pricing for a corresponding cell site that is based on an application to the second input of the underlying calculation values that were retrieved in response to receiving the first input; and
initiating building, in response to the cell planning software tool outputting the estimate, a corresponding cell site that conforms to the first input or the second input.

18. The non-transitory computer-readable medium of claim 17, wherein the output is based in part on a cooling load calculation using an equipment specification designated by the first input.

19. A system comprising:
at least one physical computing processor of a computing device; and
a non-transitory computer-readable medium that has instructions stored thereon that, when executed by the at least one physical computing processor, cause the computing device to perform operations comprising:
receiving, through a cell planning software tool, as a first input a respective value for each field in a set of fields comprising a high spectrum area indication, a cabinet type, a cooling unit type, a node support type, a distributed unit type, and an area of interest;
receiving, through the cell planning software tool, as a second value a specification of a number of distributed units or a number of nodes;
retrieving, by the cell planning software tool, in response to receiving the first input, underlying calculation values that match the first input for calculating cabinet power, cabinet cooling, or pricing;
outputting, through the cell planning software tool, an estimate of cabinet power, cabinet cooling, or pricing for a corresponding cell site that is based on an application to the second input of the underlying calculation values that were retrieved in response to receiving the first input; and
initiating building, in response to the cell planning software tool outputting the estimate, a corresponding cell site that conforms to the first input or the second input.

20. The system of claim 19, wherein the output is based in part on a cooling load calculation using an equipment specification designated by the first input.
